(19) United States
(12) Patent Application Publication
(10) Pub. No.: US 2007/0294693 A1
(43) Pub. Date: Dec. 20, 2007

(54) Scheduling thread execution among a plurality of processors based on evaluation of memory access data

(75) Inventor: Paul R. Barham, Cambridge (GB)

Correspondence Address: WOODCOCK WASHBURN LLP (MICROSOFT CORPORATION), CIRA CENTRE, 12TH FLOOR, 2929 ARCH STREET, PHILADELPHIA, PA, 19104-2891, US

(73) Assignee: Microsoft Corporation, Redmond, WA (US)

(21) Appl. No.: 11/454,557

(22) Filed: Jun. 16, 2006

(51) Int. Cl. G06F 9/46

(52) U.S. Cl. 718/102

(57) ABSTRACT

Systems and methods for scheduling thread execution among a plurality of processors based on evaluation of memory access data can comprise collecting and evaluating memory access data corresponding to two or more threads. Based on the evaluation results, it can be determined whether to prospectively assign the two or more threads to execute on different processors when they are to be executing simultaneously. A scheduler can select a processor to execute a thread, and consult an identity of threads to determine whether to assign them to the same or a different processor. The scheduler may also adjust a scheduling frequency for better thread compatibility on a single processor.

### BACKGROUND

Moore's Law says that the number of transistors we can fit on a silicon wafer doubles every year or so. No exponential lasts forever, but we can reasonably expect that this trend will continue to hold over the next decade. Moore's Law means that future computers will be much more powerful, much less expensive, there will be many more of them and they will be interconnected.

Moore's Law is continuing, as can be appreciated with reference to FIG. 1, which provides trends in transistor counts in processors capable of executing the x86 instruction set. However, another trend is about to end. Many people know only a simplified version of Moore's Law: “Processors get twice as fast (measured in clock rate) every year or two.” This simplified version has been true for the last twenty years but it is about to stop. Adding more transistors to a single-threaded processor no longer produces a faster processor. Increasing system performance must now come from multiple processor cores on a single chip. In the past, existing sequential programs ran faster on new computers because the sequential performance scaled, but that will no longer be true.

Future systems will look increasingly unlike current systems. We won't have faster and faster processors in the future, just more and more. This hardware revolution is already starting, with 2-8 core computer chip design appearing commercially. Most embedded processors already use multi-core designs. Desktop and server processors have lagged behind, due in part to the difficulty of general-purpose concurrent programming.

It is likely that in the not too distant future chip manufacturers will ship massively parallel, homogenous, many-core architecture computer chips. These will appear, for example, in traditional PCs and entertainment PCs, and cheap supercomputers. Each processor die may hold fives, tens, or even hundreds of processor cores.

In a multicore environment, processors are cheaply available for use by the various processes and threads that are managed by an operating system. However, it is important in some circumstances to keep related threads on a single processor. Other threads may have varying degrees of compatibility which yield varying degrees of advantage in outsourcing a thread to a separate processor. Adjusting the scheduling frequency of a processor also affects thread compatibility. There is a need in the industry to intelligently collect thread compatibility information in order to make good decisions about how available processing power can best be utilized.

### SUMMARY

In consideration of the above-identified shortcomings of the art, the present invention provides systems and methods for scheduling thread execution among a plurality of processors based on evaluation of memory access data. First, memory access data corresponding to two or more threads can be collected and evaluated. Such data may be collected by a hardware extension coupled to a processor. The data may be evaluated for example by an operating system component. Based on the results, it can be determined whether to prospectively assign the two or more threads to execute on different processors when they are to be executing simultaneously. A scheduler can select a processor to execute a thread, and consult an identity of threads to determine whether to assign them to the same or a different processor. The scheduler may also adjust a scheduling frequency for better thread compatibility on a single processor. Other embodiments, features and advantages of the invention are described below.

### BRIEF DESCRIPTION OF THE DRAWINGS

The systems and methods for scheduling thread execution among a plurality of processors based on evaluation of memory access data in accordance with the present invention are further described with reference to the accompanying drawings in which:

FIG. 1 illustrates trends in transistor counts in processors capable of executing the x86 instruction set.

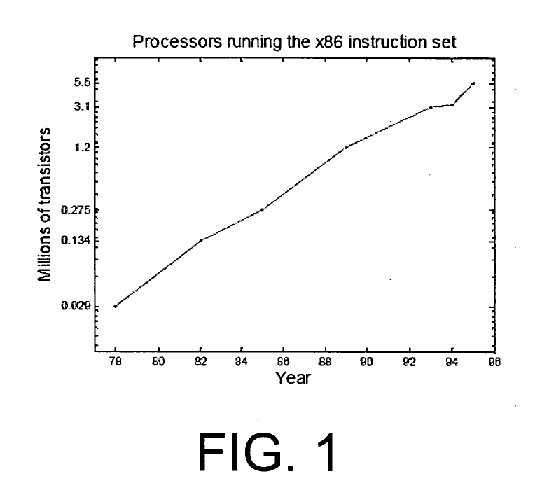

FIG. 2 illustrates a multicore computer chip that comprises a variety of exemplary components such as several general purpose controller, graphics, and digital signal processing computation powerhouses.

FIG. 3 illustrates an overview of a system with an application layer, and OS layer, and a multicore computer chip.

FIG. 4 illustrates an operating system 400 that is accessed by applications 411-413 via API 401. The OS 400 manages threads associated with the applications on a multicore chip 450. Chip 450 has processors 471, 481, 485, and 491. Hardware extensions 473, 483, 487, 493 on the processors collect and emit cache diagnostic data (“memory access data” 452) to memory 451. The evaluation module 402 can then evaluate the memory access data 452 and determine which threads are compatible/incompatible. The scheduler 402 can subsequently schedule threads accordingly. If threads are related, and cannot be practically placed on different processors, then scheduler 402 may also adjust the scheduled frequency of context switches.

FIG. 5 illustrates an exemplary method for evaluating memory access data and then scheduling threads according to what is learned.

FIG. 6 illustrates a method for another embodiment of the method illustrated in FIG. 5. Here, memory access data is pretested and applications come with thread compatibility information. The OS can simply schedule threads according to the compatibility information announced by applications.

FIG. 7 illustrates various aspects of an exemplary computing device in which the invention may be deployed.

### DETAILED DESCRIPTION

Certain specific details are set forth in the following description and figures to provide a thorough understanding of various embodiments of the invention. Certain well-known details often associated with computing and software technology are not set forth in the following disclosure, however, to avoid unnecessarily obscuring the various embodiments of the invention. Further, those of ordinary skill in the relevant art will understand that they can practice other embodiments of the invention without one or more of the details described below. Finally, while various methods are described with reference to steps and sequences in the following disclosure, the description as such is for providing a clear implementation of embodiments of the invention, and the steps and sequences of steps should not be taken as required to practice this invention.

When scheduling execution of threads on multicore computer chips it is very important to have good information about their locality of accesses in the instruction and data caches. This is because some threads are related and it is impractical to assign them to different processors, while other threads can be more and less compatible, resulting in more and less advantage to assigning them to different processing cores. Current processors have only limited and model-specific hardware performance counters. These count low-level processor-internal hardware events, e.g., branch mispredicts and cache line fills. Some processors allow the operating system to receive an interrupt when these counters reach a particular value. Operating systems for multicore machines benefit from a more complete set of performance counters, as provided herein, which allow the operating system to cheaply determine the cache and memory-system footprints of threads allowing them to be assigned to cores in a more principled fashion.

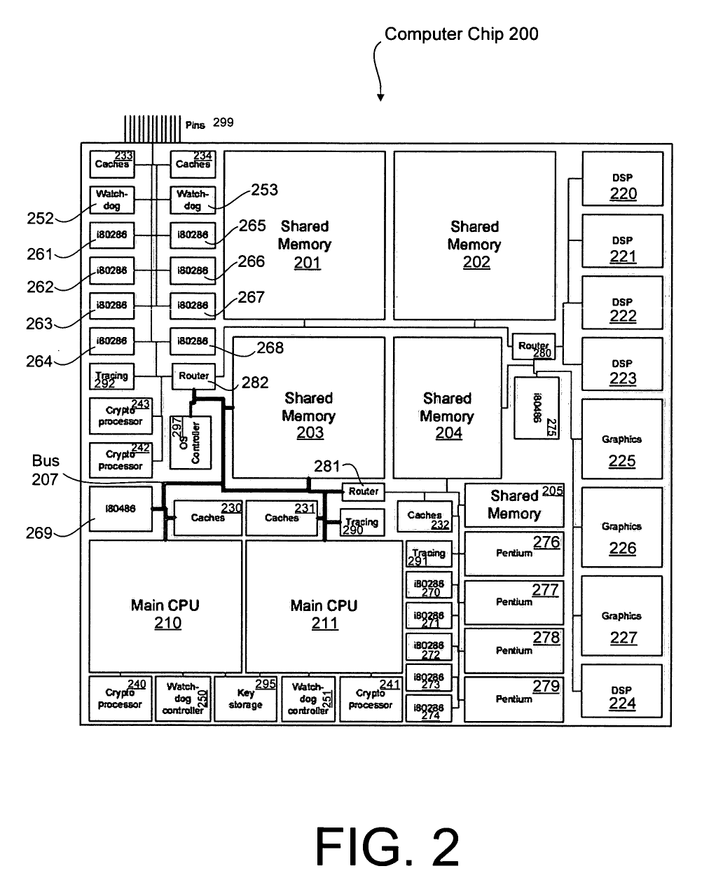

FIG. 2 gives an exemplary computer chip 200 that comprises a wide variety of components. Though not limited to systems comprising chips such as chip 200, it is contemplated that aspects of the invention are particularly useful in multicore computer chips, and the invention is generally discussed in this context. Chip 200 may include, for example, several general purpose controller, graphics, and digital signal processing computation powerhouses. This allows for maximum increase of localized clock frequencies and improved system throughput. As a consequence, system's processes are distributed over the available processors to minimize context switching overhead.

It will be appreciated that a multicore computer chip 200 such as that of FIG. 2 can comprise a plurality of components including but not limited to processors, memories, caches, buses, and so forth. For example, chip 200 is illustrated with shared memory 201-205, exemplary bus 207, main CPUs 210-211, a plurality of Digital Signal Processors (DSP) 220-224, Graphics Processing Units (GPU) 225-227, caches 230-234, crypto processors 240-243, watchdog processors 250-253, additional processors 261-279, routers 280-282, tracing processors 290-292, key storage 295, Operating System (OS) controller 297, and pins 299.

Components of chip 200 may be grouped into functional groups. For example, router 282, shared memory 203, a scheduler running on processor 269, cache 230, main CPU 210, crypto processor 240, watchdog processor 250, and key storage 295 may be components of a first functional group. Such a group might generally operate in tighter cooperation with other components in the group than with components outside the group. A functional group may have, for example, caches that are accessible only to the components of the group.

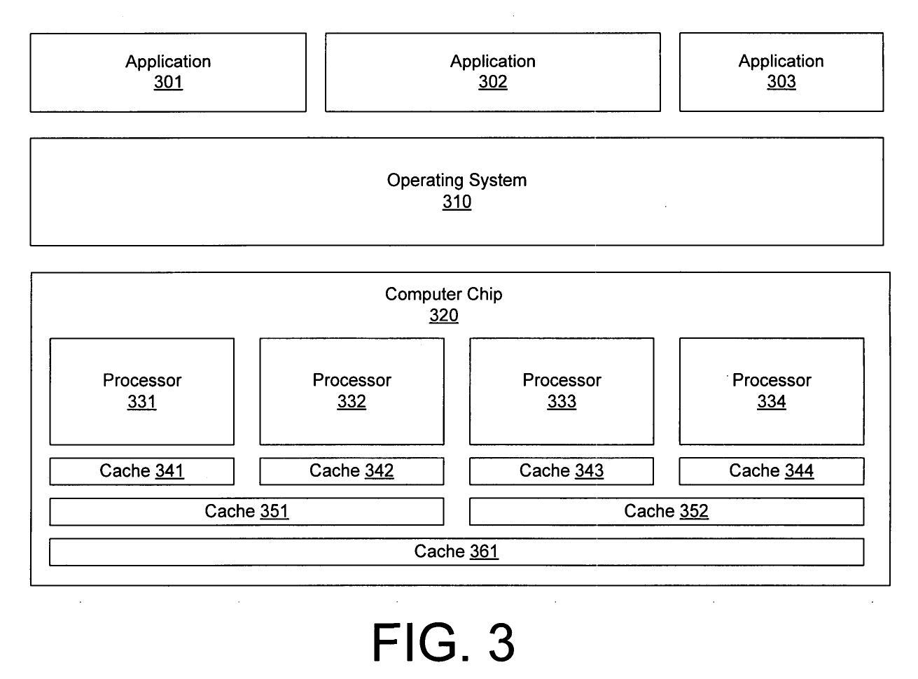

FIG. 3 illustrates an overview of a system with an application layer, and operating system (OS) layer, and a multicore computer chip 320. The OS 310 is executed by the chip 320 and typically maintains primary control over the activities of the chip 320. Applications 310-303 access hardware such as chip 320 via the OS 310. The OS 310 manages chip 320 various ways that may be invisible to applications 301-303, so that much of the complexity in programming applications 301-303 is removed.

A multicore computer chip such as 320 may have multiple processors 331-334 each with various levels of available cache. For example, each processor 331-334 may have a private level one cache 341-344, and a level two cache 351 or 352 that is available to a subgroup of processors, e.g. 331-332 or 334-334, respectively. Any number of further cache levels may also be accessible to processors 331-334, e.g. level three cache 361 which is illustrated as being accessible to processors 331-334. The interoperation of processors 331-334 and the various ways in which caches 341-344, 351-352, and 360 are accessed may be controlled by logic in the processors 331-334 themselves, e.g. by one or more modules in a processor's instruction set. This may also be controlled by OS 310 and applications 301-303.

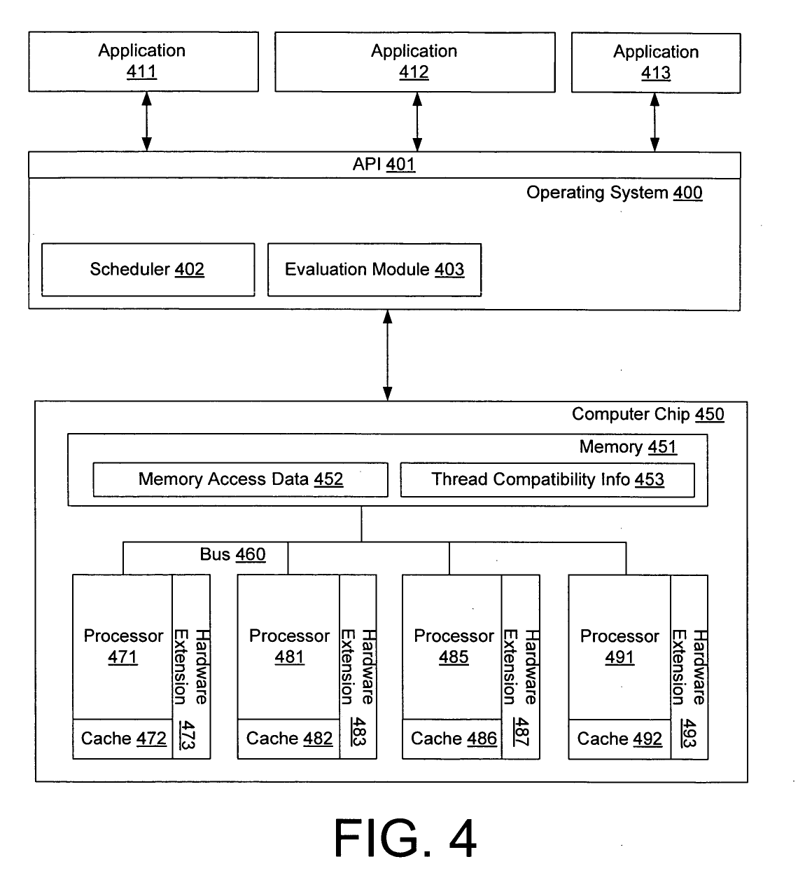

FIG. 4 illustrates an operating system 400 comprising an Application Programming Interface (API) 401 that supports execution of application programs 411-413 by computer hardware 450, said computer hardware 450 comprising a plurality of processors 471, 481, 485, 491. Operating system 400 also comprises a scheduler 402 for scheduling execution of threads associated with said application programs 411-413, wherein said scheduler 402 selects a processor 471 from said plurality of processors 471, 481, 485, 491 to execute a thread, and wherein said scheduler 402 consults information comprising an identity of threads that may be simultaneously executing on said plurality of processors 471, 481, 485, 491.

An API 401 is a computer process or mechanism that allows other processes to work together. In the familiar setting of a personal computer running an operating system and various applications such as MICROSOFT WORD® and ADOBE ACROBAT READERS, an API allows the applications 411-413 to communicate with the operating system 400. An application 411 makes calls to the operating system API 401 to invoke operating system 400 services. The actual code behind the operating system API 401 is typically located in a collection of dynamic link libraries (“DLLs”).

An API 401 can be implemented in the form of computer executable instructions. These instructions can be embodied in many different forms. Eventually, instructions are reduced to machine-readable bits for processing by a computer processor 471. Prior to the generation of these machine-readable bits, however, there may be many layers of functionality that convert an API 401 implementation into various forms. For example, an API that is implemented in C++ will first appear as a series of human-readable lines of code. The API will then be compiled by compiler software into machine-readable code for execution on a processor.

Recently, the proliferation of programming languages, such as C++, and the proliferation of execution environments, such as the PC environment, the environment provided by APPLE® computers, handheld computerized devices, cell phones, and so on has brought about the need for additional layers of functionality between the original implementation of programming code, such as an API implementation, and the reduction to bits for processing on a device. Today, a computer program initially created in a high-level language such as C++ will be first converted into an intermediate language such as MICROSOFT® Intermediate Language (MSIL) or JAVA®. The intermediate language may then be compiled by a Just-in-Time (JIT) compiler immediately prior to execution in a particular environment. This allows code to be run in a wide variety of procession environments without the need to distribute multiple compiled versions. In light of the many levels at which an API 401 can be implemented, and the continuously evolving techniques for creating, managing, and processing code, the invention is not limited to any particular programming language or execution environment. The implementation chosen for description of various aspects of the invention is in no way intended to limit the invention to this implementation.

The scheduler 402 can be a process associated with the operating system 400. The scheduler 402 manages execution of applications 411-412 by assigning operations among the different processors 471, 481, 485, 491. The scheduler 402 therefore manages the resources used by application processes and threads. A brief general description of processes and threads will serve to point out the resources that are managed in this regard.

An instance of an application is known as a process. Every process has at least one thread, the main thread, but can have many. Each thread represents an independent execution mechanism. Any code that runs within an application runs via a thread. In a typical arrangement, each process is allotted its own virtual memory address space by an operating system. All threads within the process share this virtual memory space. Multiple threads that modify the same resource must synchronize access to the resource in order to prevent erratic behavior and possible access violations. In this regard, each thread in a process gets its own set of volatile registers. A volatile register is the software equivalent of a CPU register. In order to allow a thread to maintain a context that is independent of other threads, each thread gets its own set of volatile registers that are used to save and restore hardware registers. These volatile registers are copied to/from the CPU registers every time the thread is scheduled/unscheduled to run by a typical operating system.

In addition to the set of volatile registers that represent a processor state, typical threads also maintain a stack for executing in kernel mode, a stack for executing in user mode, a thread local storage (“TLS”) area, a unique identifier known as a thread ID, and, optionally, a security context. The TLS area, registers, and thread stacks are collectively known as a thread's context. Data about the thread's context must be stored and accessible by a processor that is executing a thread, so that the processor can schedule and execute operations for the thread.

In light of these resources that must be maintained by a computer for running threads, it will be acknowledged that threads are not “free,” they consume a significant amount of system resources and it is desirable to minimize the use of additional threads running on a single processor such as 471 by outsourcing them, if possible, to other processors such as 481, 485, and 491. More specifically and with reference to the above discussion of threads, each thread consumes a portion of system memory 451 that cannot be moved to a new location, and is therefore a resource-intensive use of memory 451. Operations for each running thread must be scheduled for execution either serially or on a priority basis, and time spent scheduling operations, rather than performing operations, consumes processor resources. There is also non-trivial overhead associated with switching between threads. This “context-switch overhead” is dominated by the cost of flushing the old thread's data from the cache(s) and the large number of cache misses incurred by the new thread. Each thread is allotted an amount of processor time based on the number of running threads, so more running threads will reduce the amount of processor time per thread.

Scheduler 402 or an associated operating system 400 module can select a processor, e.g., 471 from said plurality of processors 471, 481, 485, 491 to execute a thread. The processor selection may be made based on which processor 471, 481, 485, or 491 can best handle the thread in question. Thus, scheduler 402 can select a processor 471, 481, 485, or 491 after consulting information comprising an identity of threads that may be simultaneously executing on said plurality of processors 471, 481, 485, 491. Such selection can be accomplished just as in multi-processor aware operating systems available today that provide an API for restricting the set of processors on which a thread is allowed to execute. This is commonly known as thread affinity.

For example, consider a scenario in which 10 threads are simultaneously executing on processors 471, 481, 485, and 491. Threads 1, 2, and 3 are executing on processor 471. Threads 4, 5, and 6 are executing on processor 481. Threads 7, 8, and 9 are executing on processor 485. Thread 10 is executing on processor 491. “Simultaneously executing” should be understood to mean the thread is presently associated with a processor such that thread instructions either are or will soon be executing on the processor. The thread is part of the processor's current workload, but it is possible that the thread's instructions are not currently executing because some other thread is currently executing.

Now, for example, a new thread, thread 11, is started by the operating system 400. The scheduler 402 must assign thread 11 to a processor. In accordance with an embodiment of the invention, the scheduler consults the identity of threads executing on processors 471, 481, 485, 491 prior to determining which processor thread 11 will be assigned to. Thread identity can be, for example a thread ID, or some other information that identifies the thread. Thread identity may uniquely identify the thread or identify a class of threads of which the thread is a member. Thread identity therefore is any information which distinguishes a thread from at least one other thread.

Thread identity is consulted because scheduler 402 may have information regarding thread compatibility. For example, the scheduler may select a single processor 471 from a plurality of processors 471, 481, 485, and 491 for execution of two or more related threads. The scheduler 402 may select two or more separate processors 471 and 481 from the plurality of processors 471, 481, 485, and 491 for execution of incompatible threads.

Information as to whether threads are related or incompatible, or as to a degree of compatibility of threads may be gathered, for example, by hardware extensions 473, 483, 487, and 493, which collect and store memory access data 452 in memory 451. For example, when two threads are executing of a processor 471, hardware extension 473 can measure information such as frequency of cache access, number of memory locations a thread is accessing, size of working set, cache hits, and cache misses. This information can be stored in memory 451 as memory access data 452. While hardware extensions 473, 483, 487, and 493 are illustrated in an on-chip or processor integrated configuration, this is not required and 473, 483, 487, and 493 may just as well be memory units located off-chip, such as an implementation in which this function can be performed by a computer's main memory.

Memory access data 452 may be evaluated by evaluation module 403. Evaluation module 403 can evaluate memory access data 452 to determine whether two or more threads are prospectively compatible for simultaneous execution on a single processor 471, incompatible for simultaneous execution on a single processor 471, or a degree of compatibility for simultaneous execution on a single processor 471. In order to gather the memory access data, it may be that the two or more threads were executed by a single processor 471. However, if such a processor assignment resulted in low performance, those threads can be assigned to different processors prospectively. Thread compatibility information 453 can be stored by evaluation module 403 and consulted when starting a new thread, or when migrating an existing thread to a new processor.

Thread compatibility information 453 may also be used by scheduler 402 to adjust a thread scheduling frequency. Some threads benefit from longer uninterrupted execution times, while other threads can be context-switched more frequently. Evaluation module 403 may determine an optimum scheduling frequency for threads for situations in which multiple threads must be assigned to a same processor.

Another aspect of the invention, which may also be appreciated from FIG. 4, is directed to a hardware configuration that supports collection of thread compatibility information. Such a hardware configuration may comprise a computer chip 450 comprising a plurality of processors 471, 481, 485, and 491, each processor having a cache memory 472, 482, 486, 492. Each processor may further be equipped with, or otherwise coupled to a hardware extension 473, 483, 487, 493, wherein said hardware extension detects and emits cache access data 452, said cache access data 452 comprising frequency of cache access by said at least one processor 471, 481, 485, and 491. As discussed above, the cache access data may further comprise a number of cache hits, a number of cache misses, and so on.

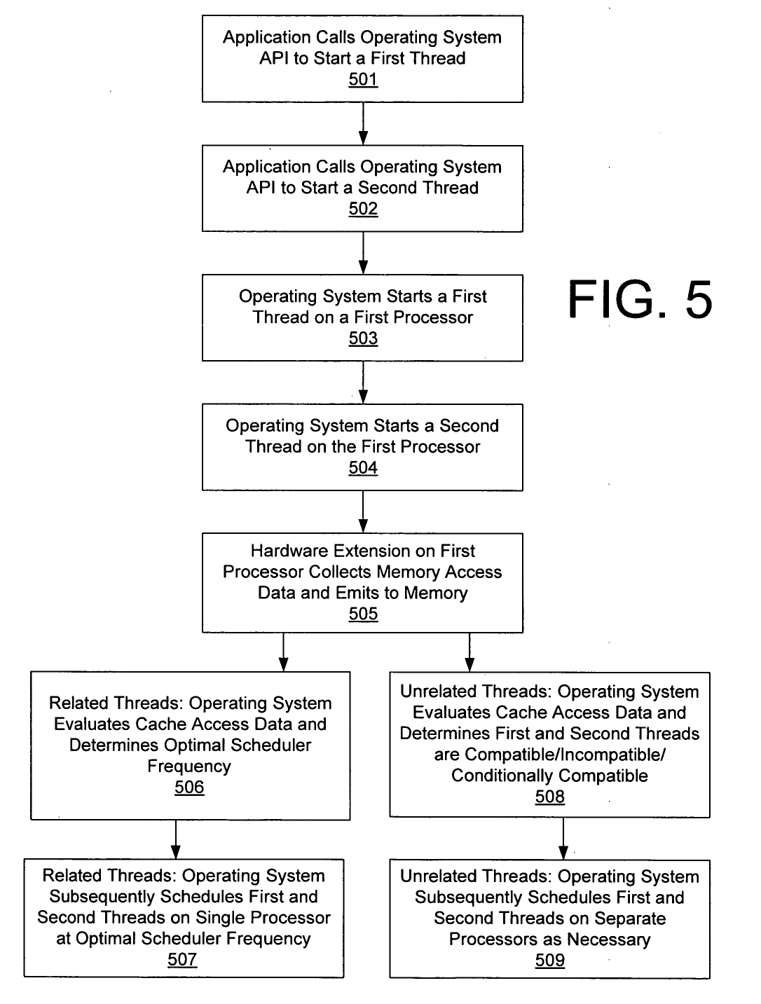

FIG. 5 generally illustrates a method for scheduling thread execution among a plurality of processors, comprising evaluating memory access data corresponding to two or more threads 508 and based on results of said evaluating, determining whether to prospectively assign said two or more threads to execute on different processors when said two or more threads are to be executing simultaneously 509.

As should be clear from the above, memory access data referenced in FIG. 5 may comprise cache access data, such as cache hits and cache misses, a size of a working set for said two or more threads, a frequency of attempts by a thread to access a cache memory, and a number of memory locations accessed by a thread. Memory access data may also include information gathered by cache-coherency protocol such as Modified, Exclusive, Shared, Invalid (MESI). MESI is an exemplary cache-coherency protocol used in some modern multi-processor systems. Using MESI, various caches attempt to keep themselves consistent by keeping track of the state of each cached memory location. Information used by MESI includes counts of the number of cache lines in various states and the number of transitions between each pair of states. Such information can be useful for thread scheduling in accordance with the invention. The processors may be located on a single computer chip such as the chip illustrated in FIG. 2.

Starting with step 501, in one contemplated embodiment of the invention, an application may call an operating system API to start a first thread 501. The operating system may start the desired thread on a first processor 503. Next, an application which may be a same or different application calls the operating system API to start a second thread 502. Assuming no pre-existing information about thread compatibility, the operating system may start the second thread on the first processor as well 504.

A hardware extension associated with the first processor may now collect memory access data to determine the compatibility of the two threads 505. In the case of related threads, for example, threads associated with a single application that frequently share and update data, the operating system or some evaluation module may evaluate memory access data to determine an optimum scheduling frequency 506. An optimum scheduling frequency may be associated with some thread identification information. When the related threads are subsequently running on a processor, the operating system may adjust the scheduling frequency for optimum performance 507.

In the case of unrelated threads, the operating system or some evaluation module may evaluate memory access data to determine compatibility of the threads 508. Information regarding compatibility, which may include a degree of compatibility and/or an optimum scheduling frequency to be used when the threads are to be executed by a same processor, may be associated with thread identification information. The threads may subsequently be assigned on separate processors as necessary 509. If the threads are very compatible, they may subsequently be placed on a same processor, at an optimum scheduling frequency. If they are marginally compatible or considered incompatible, they may assigned to different processors if possible.

FIG. 5 is generally directed to a two-thread scenario but can be extended to include assignment of any number of threads. For example, it may be determined that two threads are generally compatible, but not if a third thread is present. Alternatively, it may be determined that two threads are compatible only if a third thread is present. In another embodiment, applications and/or processes may preempt a determination of whether threads are related by flagging certain threads as related to one another. The flag can have the effect of overriding any determination of whether to prospectively assign threads to a particular processor because said two or more threads are conclusively identified as related threads. Compatibility may be analyzed for any number of threads that are simultaneously executing on a single processor.

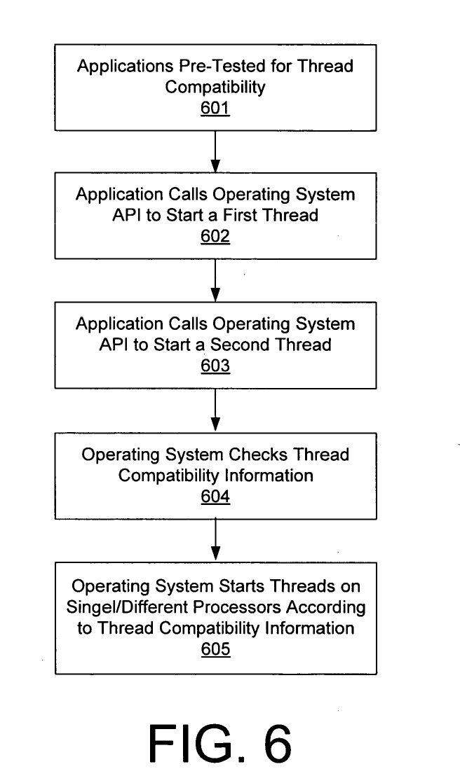

FIG. 6 illustrates another embodiment of the invention in which applications are pre-tested for thread compatibility 601. This eliminates the need for hardware extensions and thread evaluation modules on end-user machines. Instead, thread compatibility can be pre-tested, and information regarding thread compatibility can be provided to a system, for example by downloading such information to an operating system when an application is downloaded, or otherwise installing the information in an operating system file when an application is installed. Thread compatibility information may be consulted when launching a thread, just as in the case where the information is collected and evaluated pursuant to a method such as FIG. 5.

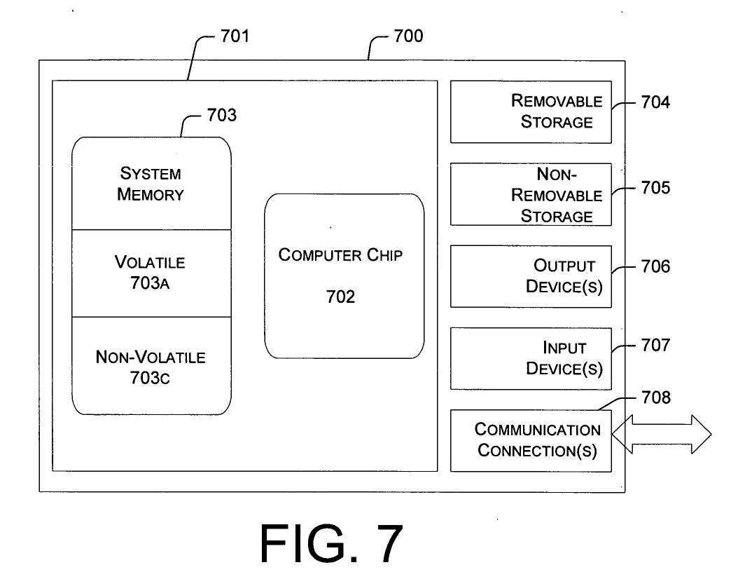

An application may be pre-tested for thread compatibility with other application threads for example by the application programmer, distributor, or a third-party testing service. The information may be provided to an end-user computing device such as that of FIG. 7. Then, when the user launches the application, it calls an API to start a first thread 602. When a second application or same application starts a second thread 603, the operating system can consult thread compatibility information 604 prior to determining an appropriate processor for the second thread 605.

FIG. 7 illustrates an exemplary computing device 700 in which the various systems and methods contemplated herein may be deployed. An exemplary computing device 700 suitable for use in connection with the systems and methods of the invention is broadly described. In its most basic configuration, device 700 typically includes a processing unit 702 and memory 703. Depending on the exact configuration and type of computing device, memory 703 may be volatile (such as RAM), non-volatile (such as ROM, flash memory, etc.) or some combination of the two. Additionally, device 700 may also have mass storage (removable 704 and/or non-removable 705) such as magnetic or optical disks or tape. Similarly, device 700 may also have input devices 707 such as a keyboard and mouse, and/or output devices 706 such as a display that presents a GUI as a graphical aid accessing the functions of the computing device 700. Other aspects of device 700 may include communication connections 708 to other devices, computers, networks, servers, etc. using either wired or wireless media. All these devices are well known in the art and need not be discussed at length here.

The invention is operational with numerous general purpose or special purpose computing system environments or configurations. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, cell phones, Personal Digital Assistants (PDA), distributed computing environments that include any of the above systems or devices, and the like.

In addition to the specific implementations explicitly set forth herein, other aspects and implementations will be apparent to those skilled in the art from consideration of the specification disclosed herein. It is intended that the specification and illustrated implementations be considered as examples only, with a true scope and spirit of the following claims.

1. A method for scheduling thread execution among a plurality of processors, said method comprising:
evaluating memory access data corresponding to two or more threads;
based on results of said evaluating, determining whether to prospectively assign said two or more threads to execute on different processors when said two or more threads are to be executing simultaneously.

2. The method of claim 1, wherein said memory access data comprises cache access data.

3. The method of claim 2, wherein said cache access data comprises cache hits and cache misses.

4. The method of claim 1, wherein said memory access data comprises data corresponding to a size of a working set for said two or more threads.

5. The method of claim 1, wherein said memory access data comprises data corresponding to a frequency of attempts by a thread to access a cache memory.

6. The method of claim 1, wherein said memory access data comprises data corresponding to a number of memory locations accessed by a thread.

7. The method of claim 1, wherein said plurality of processors are on a single computer chip.

8. The method of claim 1, further comprising overriding said determining whether to prospectively assign because said two or more threads are related threads.

9. The method of claim 8, further comprising adjusting a scheduling frequency for said related threads, wherein a new scheduling frequency is determined based on said memory access data.

10. The method of claim 1, further comprising collecting said memory access data by at least one hardware extension that is integrated with at least one of said plurality of processors.

11. An operating system, comprising:
an Application Programming Interface (API) that supports execution of application programs by computer hardware, said computer hardware comprising a plurality of processors;
a scheduler for scheduling execution of threads associated with said application programs, wherein said scheduler selects a processor from said plurality of processors to execute a thread, and wherein said scheduler consults information comprising an identity of threads simultaneously executing on said plurality of processors.

12. The operating system of claim 11, wherein said scheduler selects a single processor from said plurality of processors for execution of two or more related threads.

13. The operating system of claim 12, wherein said scheduler adjusts a scheduling frequency for said related threads.

14. The operating system of claim 11, wherein said scheduler selects two or more separate processors from said plurality of processors for execution of incompatible threads.

15. The operating system of claim 11, further comprising an evaluation module that evaluates memory access data to determine whether two or more threads are compatible for simultaneous execution on a single processor.

16. The operating system of claim 15, wherein said memory access data comprises cache access data.

17. The operating system of claim 16, wherein said cache access data comprises cache hits and cache misses.

18. A computer chip comprising:
a plurality of processors, each processor having a cache memory;
a hardware extension coupled to least one of said processors, wherein said hardware extension detects and emits cache access data, said cache access data comprising frequency of cache access by said at least one processor.

19. The computer chip of claim 18, wherein said cache access data further comprises a number of cache hits.

20. The computer chip of claim 18, wherein said cache access data further comprises a number of cache misses.
